(19) United States
(12) Patent Application Publication
(10) Pub. No.: US 2026/0229428 A1
(43) Pub. Date: Aug. 6, 2026

(54) ILLUMINATED ELECTRICAL SWITCH DEVICE

(71) Applicant: EATON INTELLIGENT POWER LIMITED, DUBLIN 4 (IE)

(72) Inventors: Manas Das, Pune (IN); Gayatri Pandit, Pune (IN); Girish Mruthunjaya, Marietta, GA (US); Nilesh Ankush Kadam, Pune (IN); Sushant Dilip Raut, Pune (IN); Vinay Vikas Mane, Islampur (IN); Nilesh Sawai, Peachtree City, GA (US)

(73) Assignee: EATON INTELLIGENT POWER LIMITED, DUBLIN 4 (IE)

(21) Appl. No.: 19/460,568

(22) Filed: Jan. 27, 2026

Related U.S. Application Data
(60) Provisional application No. 63/750,002, filed on Jan. 27, 2025.

(51) Int. Cl. H01H 23/00; H01H 9/02; H01H 23/02; H01H 23/12

(52) U.S. Cl. CPC H01H 23/006; H01H 9/0271; H01H 23/025; H01H 23/12

(57) ABSTRACT

Illumination assemblies for an illuminated switch device are described. In one example, an illumination assembly includes a printed circuit board (PCB) assembly having a PCB including an operating circuit with a light emitting diode (LED) and circuitry for providing power to the LED when the illuminated switch device is in an OFF condition from power that is received by the illuminated switch device through the line contact and the load contact. The illumination assembly includes a first elongated contact coupled to the operating circuitry and to the line contact and a second elongated contact coupled to the operating circuitry and to the load contact. The first elongated contact and the second elongated contact are elongated strips of conductive configured to provide the power that is received by the illuminated switch device to the operating circuit for powering the LED.

### CROSS REFERENCE TO RELATED APPLICATIONS

This application claims priority to U.S. Provisional Patent Application Serial No. 63/750,002, filed on January 27, 2025 and titled “ILLUMINATED SWITCH DEVICE,” the entire contents of which are incorporated herein by reference.

### TECHNICAL FIELD

The present disclosure is directed to electrical switch devices, and, in particular, to an electrical switch having a pivoting actuator (for example, and without limitation, a toggle, rocker, paddle, and/or the like) configured to change the ON/OFF state of the electrical switch and an illumination system for illuminating a portion of the pivoting actuator based on the ON/OFF state.

### BACKGROUND

A lighted or illuminated switch device is an electrical switch configured to be illuminated based on the ON/OFF position of an actuator, such as a toggle, a paddle, a rocker, a button, and/or the like. Typically, illuminated switch devices are configured to illuminate all or a portion of the actuator when the electrical switch is in the OFF state, for instance, to provide a visual aid for locating the electrical switch in dark conditions.

Existing illuminated switch device designs typically include a traditional bulb and wire combination which, for example, is usually powered and operated by a resistor-AC circuit. Assembly of existing designs requires manual installation, which is time consuming and error prone due to the fragile nature of the bulb and wire combination. Furthermore, existing devices require space and elements for isolation within the switch device due to the heat generated by the bulb and wire combination. In addition, traditional bulbs may burn out and require replacement, necessitating disassembling the illuminated switch device.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

The present disclosure describes various embodiments of illumination assemblies for managing illumination of an electrical switch, such as a toggle switch, a rocker switch, a paddle switch, and/or the like via an LED light.

In one example an illumination assembly for an illuminated electrical switch device may include a printed circuit board (PCB) comprising at least one light emitting diode (LED) and an operating circuitry electrically coupled to the LED; and a pair of contacts, each of the pair of contacts formed of a conductive material and comprising a PCB connection end electrically coupled to the operating circuitry and a switch connection end, arranged opposite of the PCB connection end, configured to be electrically coupled to a switch contact of the illuminated electrical switch device to electrically couple the PCB to the illuminated electrical switch device.

In some embodiments of the illumination assembly, the PCB comprises a pair of apertures, each of the pair of apertures at least partially surrounded by a connection point of the operating circuitry.

In various embodiments of the illumination assembly, the PCB connection end of each of the pair of contacts is configured to be inserted through one of the pair of apertures and electrically coupled to the connection point of the one of the pair of apertures.

In some embodiments of the illumination assembly, the PCB connection end comprises a resting collar configured to engage a bottom portion of the PCB and a soldering portion configured to extend through one of the pair of apertures to be soldered to the connection point.

In exemplary embodiments of the illumination assembly, each of the pair contacts is an elongated strip of the conductive material with the switch connection end having a curved portion forming a hook-shaped end.

In various embodiments of the illumination assembly, the curved portion is configured to extend downward from the PCB into an interior cavity of the illuminated electrical switch device.

In some embodiments of the illumination assembly, the switch connection end is configured to extend through a housing aperture of a top housing of the illuminated electrical switch device to engage the switch contact to electrically couple the PCB to the illuminated electrical switch device.

In various embodiments of the illumination assembly, each of the pair of contacts is installed in a same orientation for a single pole illuminated electrical switch device with the switch connection end of each of the pair of contacts facing a same direction.

In exemplary embodiments of the illumination assembly, each of the pair of contacts is installed in a different orientation for a three-way illuminated electrical switch device with the switch connection end of each of the pair of contacts facing a different direction.

In some embodiments of the illumination assembly, the operating circuit comprises a first resistor, a first diode, the LED, a second diode, and a second resistor electrically connected in series.

In various embodiments of the illumination assembly, the first diode and the second diode provide rectification of AC power input into the illumination switch device to DC power for the LED.

In some embodiments of the illumination assembly, the operating circuit comprises a first resistor, a first diode, the LED, and a second diode connected in series, and a capacitor connected in parallel with the LED.

In various embodiments of the illumination assembly, the capacitor is configured to reduce flicker of the LED when powered on.

In one example, an illuminated electrical switch device may include a top housing; a line contact configured to be electrically coupled to a power source and a load contact configured to be electrically coupled to a load; and a printed circuit board (PCB) assembly coupled to the top housing, the PCB assembly comprising: a PCB including an operating circuit arranged on a top surface of the PCB, the operating circuit including a light emitting diode (LED) and circuitry structured for providing power to the LED when the illuminated electrical switch device is in an OFF condition from power that is received by the illuminated electrical switch device through the line contact and the load contact, a first elongated contact coupled to the operating circuitry of the PCB and to the line contact, and a second elongated contact coupled to the operating circuitry of the PCB and the load contact, wherein the first elongated contact and the second elongated contact are configured to provide the power that is received by the illuminated electrical switch device to the operating circuit for powering the LED.

In some embodiments of the illuminated electrical switch device, the top housing includes a first aperture structured for receiving a distal end of the first elongated contact and a second aperture structured for receiving a distal end of the second elongated contact when the PCB assembly is coupled to the top housing.

In various embodiments of the illuminated electrical switch device, the top housing includes a first coupling element for snapping over and covering the PCB and a second coupling element for snapping over and covering the PCB when the distal end of the first elongated contact is received in the first aperture and the distal end of the second elongated contact is received in the second aperture when the PCB assembly is coupled to the top housing.

In various embodiments of the illuminated electrical switch device, the first elongated contact and the second elongated contact each include a hollow body, a spring provided in the hollow body, and a plunger coupled to a proximal end of the spring and extending out of a proximal end of the hollow body to be electrically coupled to one of the line contact or the load contact.

In one example, an illuminated electrical switch device may include an enclosure comprising a top housing; an actuator assembly configured to be actuated to place the illuminated electrical switch device in one of an ON state or an OFF state; a line contact configured to be electrically coupled to a power source and a load contact configured to be electrically coupled to a load; and an illumination assembly, comprising: a printed circuit board (PCB) including at least one light emitting diode (LED) and an operating circuitry electrically coupled to the LED, and a pair of contacts, each of the pair of contacts formed as a strip of conductive material and comprising a PCB connection end electrically coupled to the operating circuitry and a switch connection end, arranged opposite of the PCB connection end, electrically coupled to one of the line contact or the load contact, wherein the illumination assembly is configured to illuminate a portion of the actuator assembly when the illuminated switch device is in the OFF state.

In some embodiments of the illuminated electrical switch device, the PCB comprises a pair of apertures, each of the pair of apertures at least partially surrounded by a connection point of the operating circuitry, and the PCB connection end of each of the pair of contacts is configured to be inserted through one of the pair of apertures and electrically coupled to the connection point of the one of the pair of apertures.

In various embodiments of the illuminated electrical switch device, the switch connection end includes a curved portion extending downward from the PCB and through a housing aperture of the top housing to electrically couple with one of the line contact or the load contact.

In one example, an illuminated switch device includes a housing member, a first contact coupled to the housing member, a second contact coupled to the housing member, and a printed circuit board (PCB) assembly coupled to the housing member, the PCB assembly including a printed circuit board, a circuit provided on the printed circuit board including a light emitting diode (LED) and circuitry structured for providing power to the LED when the illuminated switch device is in an OFF condition from power that is received by the illuminated switch device through the first contact and the second contact when the illuminated switch device is in the OFF condition, a first elongated contact member coupled to a first side of the printed circuit board and to the first contact, and a second elongated contact member coupled to a second side of the printed circuit board, wherein the first elongated contact member and the second elongated contact member are coupled to the circuit and are structured to provide the power that is received by the illuminated switch device to the circuit for powering the LED.

### BRIEF DESCRIPTION OF THE DRAWINGS

By way of example, features of the disclosed components and systems are described with reference to the accompanying drawings, in which:

FIG. 1 depicts an exploded view of an illustrative example of an illuminated switch device in accordance with the present disclosure;

FIGS. 2A-2E depict various views of an illustrative example of a first embodiment of an illumination assembly in accordance with the present disclosure;

FIGS. 3A and 3B depict various views of an illustrative example of a second embodiment of an illumination assembly in accordance with the present disclosure;

FIGS. 4A-4C depict various views of an illustrative example of a third embodiment of an illumination assembly in accordance with the present disclosure;

FIGS. 5A and 5B depict various views of an illustrative example of a fourth embodiment of an illumination assembly in accordance with the present disclosure;

FIG. 6 depicts a top perspective view of a top housing of an illustrative example of an illuminated switch device in accordance with the present disclosure;

FIG. 7 depicts a perspective view of an illustrative example of an illuminated switch device in accordance with the present disclosure;

FIG. 8A depicts a top plan view of an illustrative example of an illuminated switch device in accordance with the present disclosure;

FIGS. 8B and 8C depict detailed views of the illuminated switch device of FIG. 8A;

FIG. 9 depicts a sectioned view of an illustrative example of an illuminated switch device in accordance with the present disclosure;

FIGS. 10-13 depict illustrative examples of circuit diagrams of illumination assemblies in accordance with the present disclosure; and

FIG. 14 depicts an illustrative example of operating circuitry of an illumination assembly in accordance with the present disclosure.

### DETAILED DESCRIPTION

Various features of illuminated electrical switch devices (“illuminated switches” or “illuminated switch devices”) are described in the present disclosure, with reference to the accompanying drawings, in which one or more features of the illuminated electrical switch devices are shown and described. The various features described in the present disclosure and depicted in the accompanying drawings may be used independently of, or in combination, with each other. Illuminated electrical switch devices as disclosed herein may be embodied in many different forms and should not be construed as being limited to the examples set forth herein. Rather, these examples are provided to convey certain features of the illuminated electrical switch devices to those skilled in the art.

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts or components are “coupled” shall mean that the components are joined or operate together either directly or indirectly, for instance, through direct contact, through one or more intermediate parts or components, and/or through the communication or flow of data, electricity, power, current, and/or the like between the components (for example, “communicatively coupled” or “electrically coupled”).

As employed herein, ordinal terms such as “first” and “second” are used to distinguish one item from another, and are not intended to require a sequential order unless specifically stated.

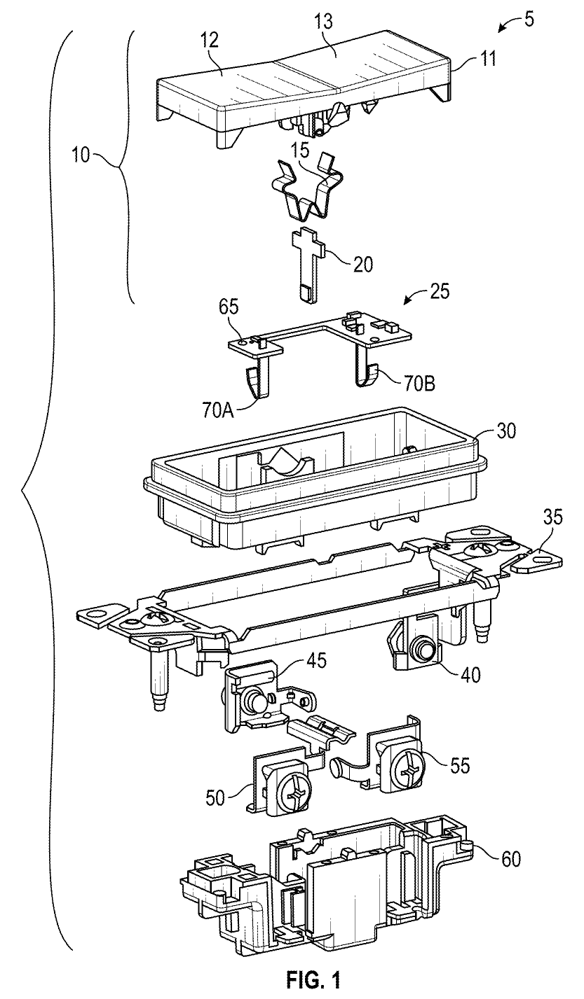

FIG. 1 depicts an exploded view of an illustrative example of an illuminated switch device in accordance with the present disclosure. As shown in FIG. 1, an illuminated switch device 5 may include an actuator or actuator assembly 10 configured to be operated to turn the illuminated switch device 5 ON and OFF. The actuator 10 may be configured according to various currently-existing or future-developed actuator types, including, without limitation, a toggle switch, a paddle switch, a rocker switch, a button switch (for example, with one or two ON/OFF buttons), and/or the like.

In general, the actuator 10 may include at least one manual actuation element configured to be manipulated by a user into one of an ON or OFF position to place the illuminated switch device 5 into an ON or OFF state. In the ON state, electricity is able to flow through the circuit of the illuminated switch device 5 to power one or more loads electrically coupled to the illuminated switch device 5. In the OFF state, the circuit of the illuminated switch device 5 is open and electricity is prevented from flowing through the circuit of the illuminated switch device 5 to power the one or more loads. The manual actuation element may be coupled to one or more connection elements configured to allow the physical manipulation of the manual actuation element to change the state of the illuminated switch device 5 circuitry to be in one of the ON state or the OFF state.

In the illustrative example of FIG. 1, the actuator 10 is a paddle switch having a paddle 11 as the manual actuation element. The paddle 11 includes an ON surface 12 and an OFF surface 13 (for instance, pushing the ON surface 13 turns the illuminated switch device 5 ON and pushing the OFF surface 12 turns the illuminated switch device 5 OFF). The paddle 11 is coupled to a spring 15 and a flipper member 20. The paddle 11, spring 15, and flipper member 20 operate together to enable the illuminated switch device 5 to be moved between OFF and ON states.

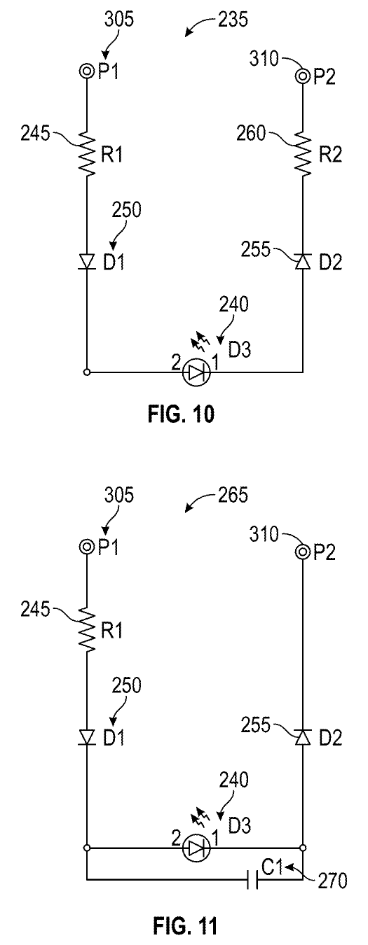

The illuminated switch device 5 includes an illumination assembly 25. The illumination assembly 25 may include a printed circuit board (PCB) 65 and contacts (“PCB contacts” or “illumination assembly contacts”) 70A and 70B. The illumination assembly 25 includes circuitry (see, for example, FIGS. 10-14) for illuminating the illuminated switch device 5 when in the OFF state. In some embodiments, the circuitry of the illumination assembly 25 includes a light emitting diode (LED). In various embodiments, the circuitry of the illumination assembly 25 may include circuitry and electrical elements for converting AC power to DC power for powering the LED when the illuminated switch device 5 is in the OFF condition.

The illuminated switch device 5 may include a strap assembly 35. A plurality of contacts (or “switch contacts”) may be coupled to the strap assembly 35, including, for example and without limitation, a line contact 40, a load contact 45, and additional contacts 50 and 55. The contacts 40, 45, 50, and/or 55 may be configured to be connected to a power source, such as AC utility power, for powering one or more loads connected to the illuminated switch device 5. In various embodiments, the line contact 40 and the load contact 45 are interchangeable (for instance, the line contact 40 can be used for the load and the load contact 45 can be used for the line connection). The illuminated switch device 5 may include a bottom housing 60 configured to be coupled to the top housing 30 to form a secure enclosure for the components of the illuminated switch device 5.

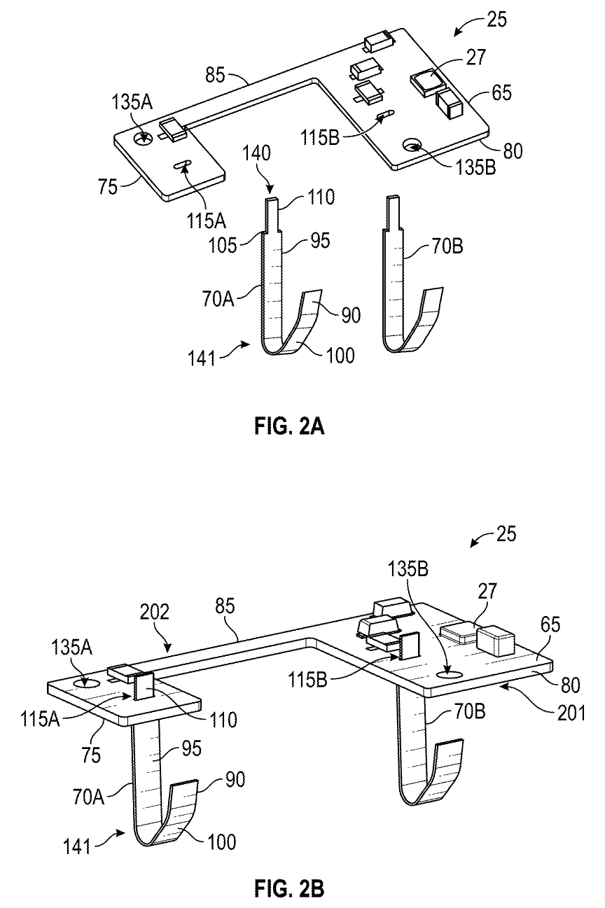

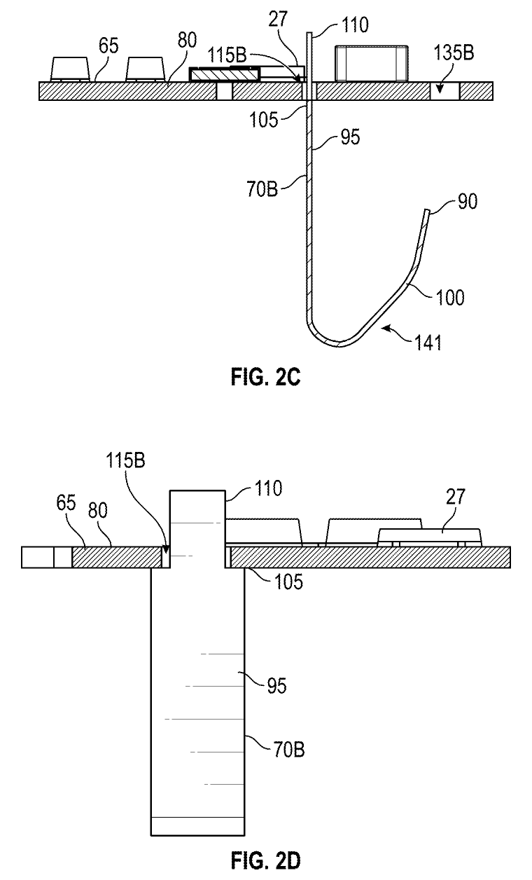

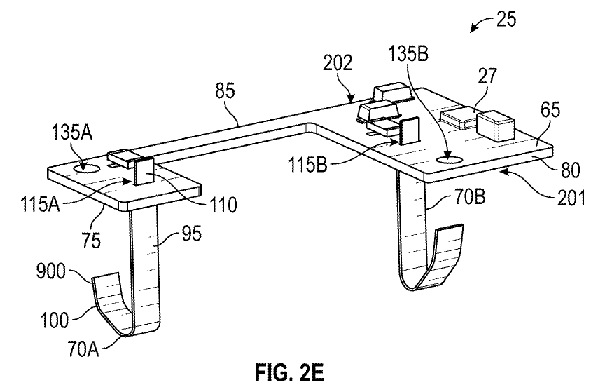

FIGS. 2A-2E depict various views of an illustrative example of a first embodiment of an illumination assembly in accordance with the present disclosure. More specifically, FIG. 2A depicts an exploded top perspective view of the illumination assembly 25, FIG. 2B depicts a top perspective view of the illumination assembly 25, FIG. 2C depicts a side sectioned view of the illumination assembly 25, FIG. 2D depicts a front sectioned view of the illumination assembly 25, and FIG. 2E depicts a top perspective view of the illumination assembly 25 in a three-way switch configuration.

As shown in FIGS. 2A-2E, the illumination assembly 25 includes a PCB 65, having the LED 27 arranged on a top surface thereof, and contacts 70A and 70B (for instance, a first contact 70A and a second contact 70B) attached to opposite ends 75 and 80 of the PCB 65. In exemplary embodiments, the PCB 65 may have a U-shape that includes a first side portion 75, a second side portion 80, and a connecting portion 85 provided in between the first side portion 75 and the second side portion 80. The longitudinal axis of the first side portion 75 and the longitudinal axis of the second side portion 80 may be parallel to one another, and the longitudinal axis of the connecting portion 85 is perpendicular to the longitudinal axes of the first side portion 75 and the second side portion 80. The PCB 65 is not limited to having a U-shape as this is provided for illustrative purposes. The PCB 65 may have various shapes, dimensions, configurations, and/or the like and operate according to various embodiments.

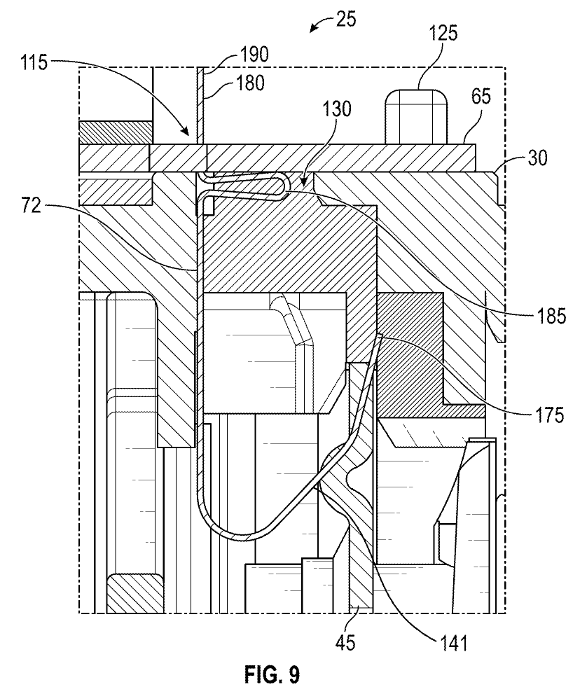

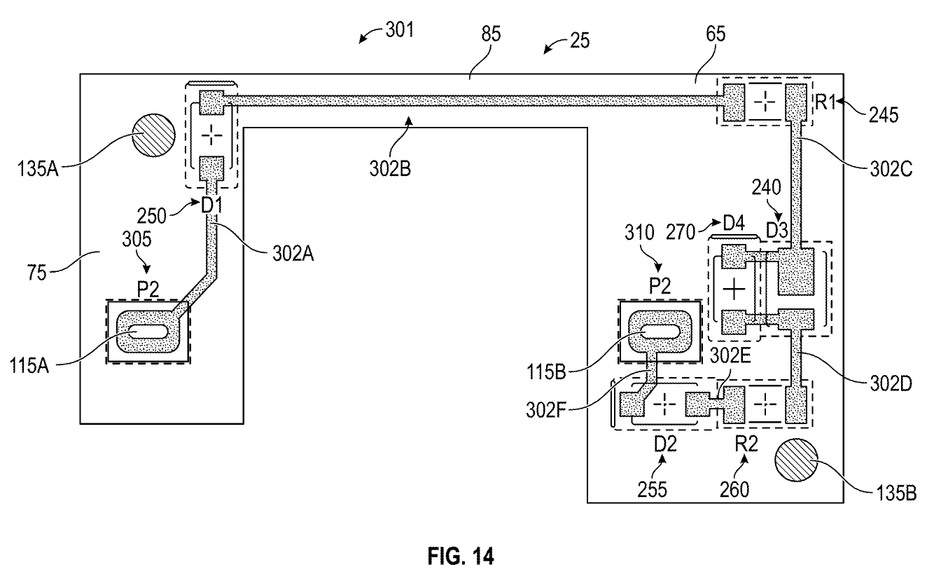

In some embodiments, the contacts 70A and 70B are configured to electrically couple the PCB 65 to the circuitry of the illumination assembly 25 (see, for example, FIGS. 9-14). The contacts 70A and 70B may be formed of a conductive material, including, without limitation, a metal, copper, aluminum, combinations thereof, alloys thereof, and/or the like. In various embodiments, each of the contacts 70A and 70B may have the same or essentially the same configuration. In some embodiments, the contacts 70A and 70B may be formed as an elongated strip of conductive material. In various embodiments, each of the contacts 70A and 70B may include a switch connection portion 141 configured to be electrically coupled to the circuitry of the illuminated switch device and a PCB connection portion 140 configured to be soldered or otherwise electrically coupled to the PCB 65. In various embodiments, soldering may not be required and the contacts 70A and 70B may be electrically coupled to the PCB 65 via a friction fit with conductive material (for instance, P1 305 and P2 310 of FIG. 14).

In some embodiments, each of the contacts 70A and 70B may be or may be substantially hook-shaped or J-shaped. In various embodiments, each of the contacts 70A and 70B may include a distal end 90, a proximal end 95, and a curved portion 100 provided between the distal end 90 and the proximal end 95 (only one contact 70A is labeled to simplify the figures). The switch connection portion 141 may include the curved portion. The curved portion 100 may be flexible and biased toward maintaining a curved shape. For instance, if the distal end 90 is pushed toward the proximal end 95 and the pushing force is removed, the distal end 90 is biased to move away from the proximal end 95. The contacts 70A and 70B may be configured to extend downward from the PCB 65 (and into the interior of the illuminated switch device 5; see, for example, FIGS. 7 and 9).

The proximal end 95 may include a resting collar 105 and a soldering portion 110 extending upwardly from the resting collar 105. The contacts 70A and 70B may be formed of a conductive material, including, without limitation, a metal, copper, aluminum, combinations thereof, alloys thereof, and/or the like. The resting collar 105 may be configured to engage with a bottom surface of the PCB 65 (for instance, the top surface of the PCB 65 may have the LED arranged thereon and the bottom surface is the opposite surface, facing the interior of the illuminated switch device 5).

In various embodiments, the illumination assembly 25 is assembled by inserting the soldering portion 110 of the contact number 70A and the contact member 70B through respective apertures 115A and 115B (for example and without limitation, slotted apertures) that are provided in PCB 65. The soldering portion 110 of each of the contacts 70A and 70B is then soldered to the circuitry of the PCB 65. For example, the contacts 70A and 70B may be soldered to electrical traces (see, for example, FIG. 14) that are provided on and/or within the PCB 65 and that form part of the circuitry of the PCB 65.

Referring to FIGS. 2B and 2E, the contacts 70A and 70B may be soldered or otherwise coupled to the PCB 65 in different configurations, for instance, depending on the type of the illuminated switch device 5. For example, for a single pole illuminated switch device 5, each of the contacts 70A and 70B may have the same orientation (for instance, the distal end 90 of each of the contacts 70A and 70B may face in the same direction, for example and without limitation, toward a front side 201 of the PCB 65). In another example, for a three-way illuminated switch device 5, each of the contacts 70A and 70B may have an opposite or otherwise different orientation (for instance, the distal end 90 of contact 70A may face toward a back side 202 of the PCB 65 and the distal end 90 of contact 70B may face toward the front side 201 of the PCB 65).

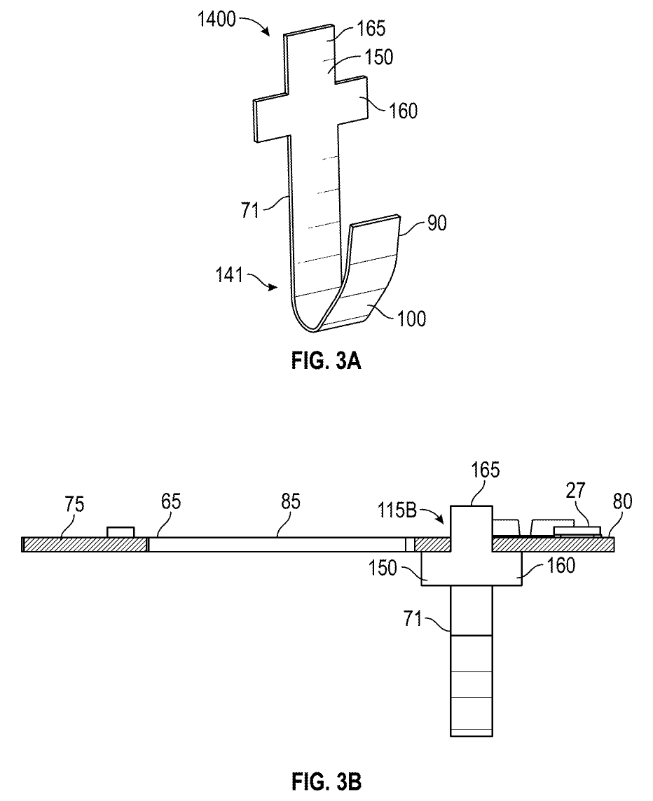

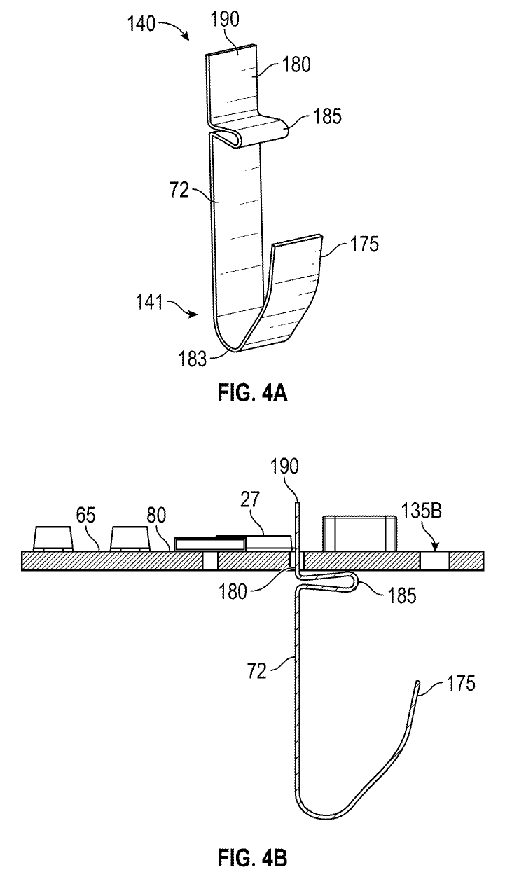

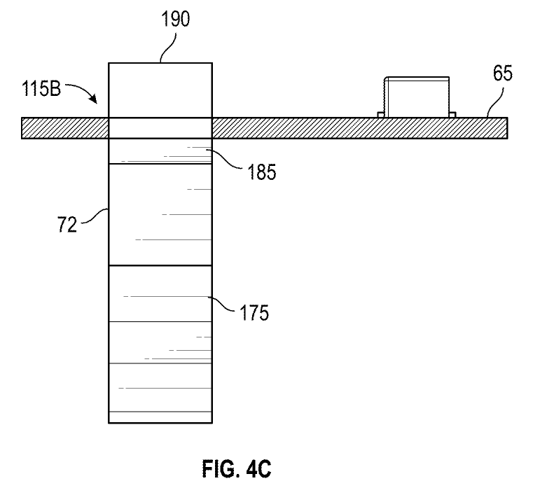

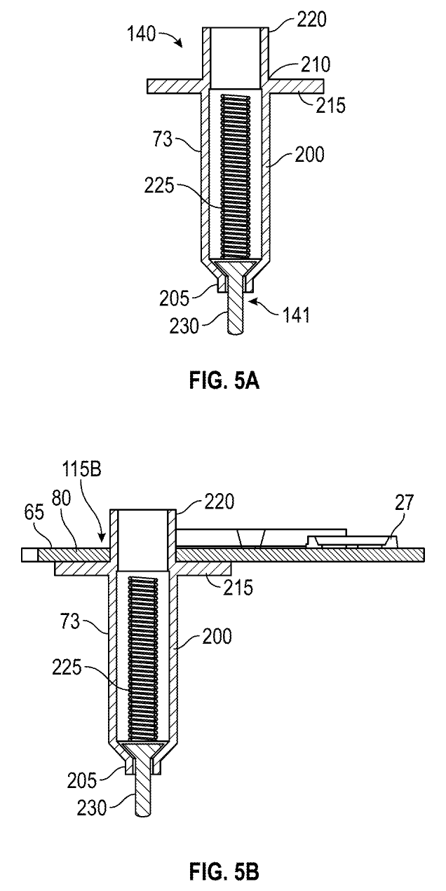

The configuration of the contacts 70A and 70B are for illustrative purposes as the illumination assembly 25 may use different types of contacts. For example, FIGS. 3A and 3B depict various views of an illustrative example of a second embodiment of an illumination assembly in accordance with the present disclosure, FIGS. 4A-4C depict various views of an illustrative example of a third embodiment of an illumination assembly in accordance with the present disclosure, and FIGS. 5A and 5B depict various views of an illustrative example of a fourth embodiment of an illumination assembly in accordance with the present disclosure.

Referring to FIGS. 3A and 3B, the illumination assembly 25 may include a pair of contacts having the form of contact 71. In various embodiments, the contact 71 may include a proximal end 150 having a transverse portion 160 providing a resting collar and a soldering portion 165 extending upwardly from the transverse portion 160 such that the proximal end 150 is or is substantially T-shaped or a cross-shaped. The soldering portion 165 may be soldered to the circuitry of the PCB 65 according to various embodiments.

Referring to FIGS. 4A-4C, the illumination assembly 25 may include a pair of contacts having the form of contact 72. In some embodiments, the contact 72 may include a distal end 175, a proximal end 180, and a curved portion 183 provided between the distal end 175 and the proximal end 180. The proximal end 180 may include a folded portion 185 providing a resting collar and a soldering portion 190 extending upwardly from the transverse folded portion 185. The soldering portion 190 may be soldered to the circuitry of the PCB 65 according to various embodiments.

Referring to FIGS. 5A and 5B, the illumination assembly 25 may include a pair of contacts having the form of contact 73. In some embodiments, the contact 73 may include a hollow body 200 having a distal end 205 and a proximal end 210. The proximal end 210 includes a transverse portion 215 providing a resting collar and a soldering portion 220 extending upwardly from the transverse portion 215 such that the proximal end 210 is or is substantially T-shaped or a cross-shaped. The soldering portion 220 may be soldered to the circuitry of the PCB 65 according to various embodiments.

In various embodiments, a spring 225 is provided inside the hollow body 200, and a plunger 230 is attached to the distal end of the spring 225 such that the plunger 230 extends outwardly from the distal end 205 of the hollow body 200. The plunger 230 is structured to be pushed vertically inside the PCB assembly 25 when the PCB assembly 25 is mounted in the top housing 30. The plunger 230 is structured to make electrical contact with the line or load contacts 40 and 45 of the strap assembly 35.

In some embodiments, each contact of the illumination assembly 25 may have the same form (for instance, a pair of contacts of type 70, a pair of contacts of type 71, a pair of contacts of type 72, or a pair of contacts of type 73). In various embodiments, the illumination assembly 25 may include a pair of contacts of different types (for instance, a first contact of type 70 and a second contact of type 71, a first contact of type 72 and a second contact of type 71, and so on).

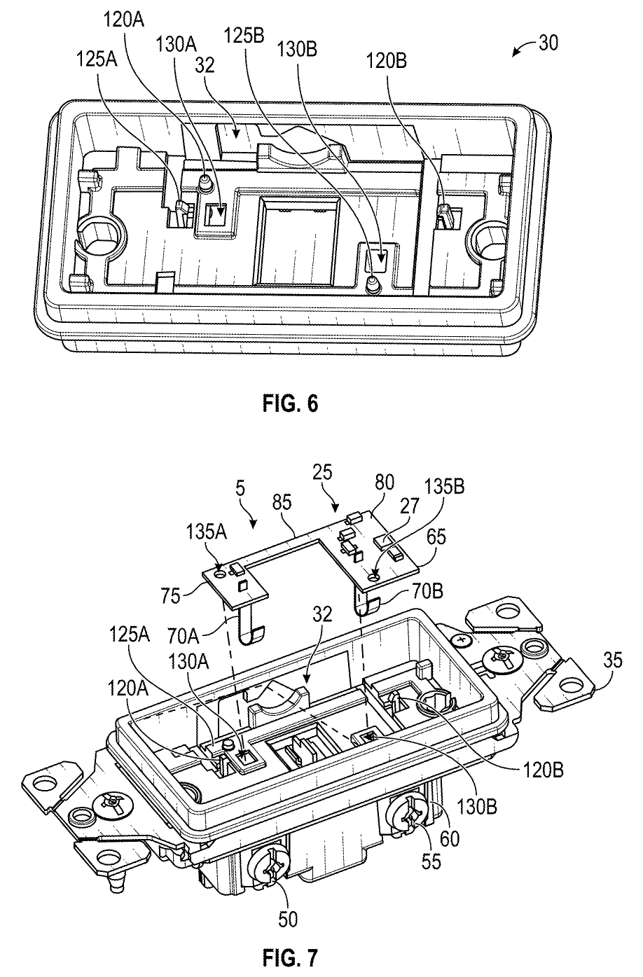

FIG. 6 depicts a top isometric view of a top housing of an illustrative example of an illuminated switch device in accordance with the present disclosure. As shown in FIG. 6, the top housing 30 may include an interior cavity 32. Within the interior cavity 32, the top housing 30 may include locating elements 120A and 120B (for example, a first locating element 120A and a second locating element 120B) extending upward (for instance, away from the bottom housing 60). In some embodiments, the locating elements 120A and 120B may be or may include projections extending from an interior surface of the top housing 30. In various embodiments, the locating elements 120A and 120B may be or may include a guide pin member. In some embodiments, the top housing 30 may include coupling elements 125A and 125B (for example, a first coupling element 125A and a second coupling element 125B) arranged within the cavity 32.

FIG. 7 depicts a perspective view of an illustrative example of an illuminated switch device in accordance with the present disclosure. As shown in FIG. 7, the illumination assembly 25 may be installed down into the cavity 32 of the top housing 30. The illumination assembly 25 may be pushed, pressed, or otherwise moved into the cavity 32 with the curved portion 100 of the contacts 70A and 70B being inserted into respective apertures (or “housing apertures”) 130A and 130B formed within the top housing 30 (see, for example, FIG. 9).

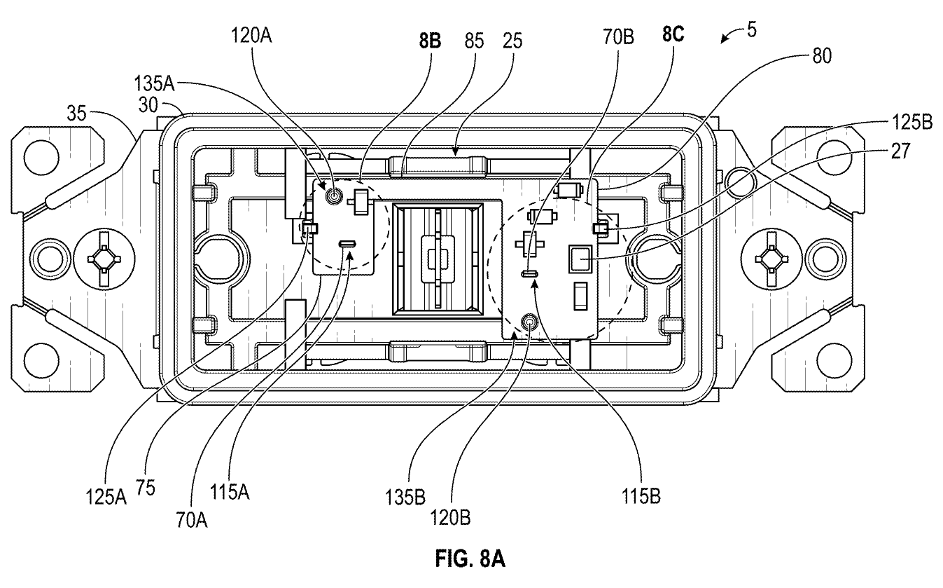

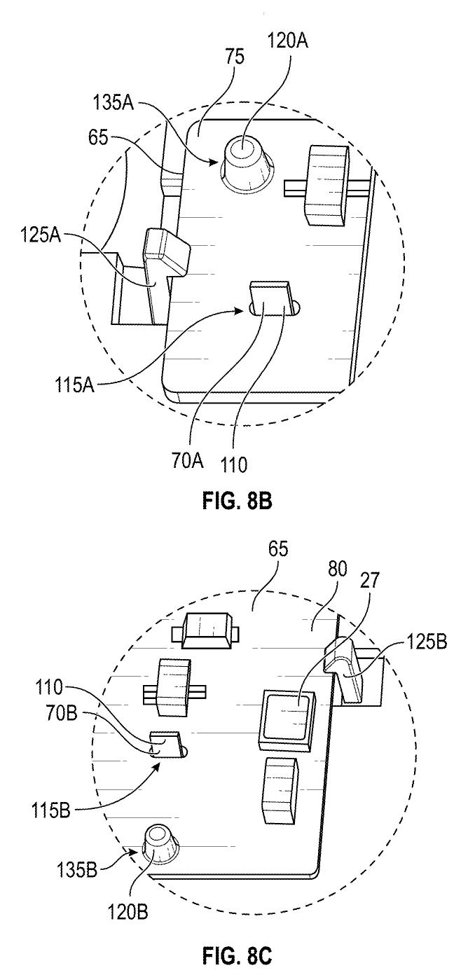

Locating holes 135A and 135B may be formed in the PCB 65 that may each spatially align with a respective coupling element 125A and 125B. For example, coupling element 125A may be inserted through locating hole 135A and coupling element 125B may be inserted through locating hole 135B. Downward pressure may then be applied to the illumination assembly 25 to cause the coupling elements 125A and 125B to be displaced outwardly and then snap back over the surface of the PCB 65 (see, for example, FIGS. 8A-8C).

FIGS. 8A-9 depict various views of an illustrative example of an illuminated switch device in accordance with the present disclosure with an illumination assembly installed within a top housing and electrically coupled to the circuitry of an illumination switch device. More specifically, FIG. 8A depicts a top plan view of an illustrative example of an illuminated switch device in accordance with the present disclosure, FIGS. 8B and 8C depict detailed views of the illuminated switch device of FIG. 8A (areas 8B and 8C of FIG. 8A, respectively), and FIG. 9 depicts a sectioned view of an illustrative example of an illuminated switch device in accordance with the present disclosure.

Referring to FIGS. 8A-8C, when the illumination assembly 25 is installed within the top housing 30, the first locating element 120A extends through the locating hole 135A and the second locating element 120B extends through the locating hole 135B. In some embodiments, one or more of the locating elements 120A or 120B may provide a friction fit with a respective locating hole 135A and 135B. Each of the coupling elements 125A and 125B may include a flange, shoulder, lip, or other structure configured to engage a top side of the PCB 65 to hold the PCB 65 permanently, semi-permanently, rigidly, semi-rigidly, and/or the like in place within the top housing 30.

Referring to FIG. 9, when the illumination assembly 25 is installed within the top housing 30, each illumination assembly contact (for instance and without limitation, contact 72) is in electrical contact with a respective illuminated switch device contact (for instance, either contact 40 or contact 45). For example, the contact 70A may be in electrical contact with the load contact 45 and the contact 70B may be in electrical contact with the line contact 40 of the strap assembly 35 in order to allow an electrical connection to be made to the circuitry of the illuminated switch device 5. The distal portion of a contact (for instance, portion 175 of contact 72) may be biased in a direction to engage (for instance, to be in press contact with) a contact (40 or 45) once the distal portion has been bent inward to push through the aperture 130.

The illumination assembly 25 when installed within the top housing in electrical communication with the circuitry of the illuminated switch device 5 may operate the LED 27 according to various embodiments when the circuitry of the illuminated switch device 5 is connected to a power supply. The illumination assembly 25 may be configured to turn the LED 27 ON and OFF based on a state of the illuminated switch device 5. For example, in some embodiments, the LED 27 may be ON when the illuminated switch device 5 is in the OFF state and the LED 27 may be OFF when the illuminated switch device 5 is in the ON state. In some embodiments, the LED 27 may be configured and arranged to illuminate only a portion of the actuator 10. For example, for a paddle actuator 10, only the OFF surface 13 may be illuminated.

FIGS. 10-13 depict illustrative examples of circuit diagrams of illumination assemblies in accordance with the present disclosure. Referring to FIG. 10, therein is depicted a circuit diagram of a circuit 235 that may be provided on the PCB 65 of the illumination assembly 25 according to some embodiments. The circuit 235 may be configured to receive and use AC power to illuminate the illuminated switch device 5 via an LED 240. In some embodiments, the LED 240 may be or may be a part of the LED 27. When the illumination assembly 25 is coupled to the top housing 30 as described herein, a first contact (for example, the contact 70A or a first contact in the form of one of contacts 71-73) is coupled at P1305 and a second contact (for example, the contact 70B or a second contact in the form of one of contacts 71-73) is coupled at P2310. The circuit 235 includes, in series, a first resistor 245, a first diode 250, the LED 240, a second diode 255, and a second resistor 260. The diodes 250 and 255 provide rectification of the AC power to DC power for the LED 240 and the resistors 245 and 260 provide appropriate size and wattage for the LED 240. The second diode 255 safeguards against voltage spikes caused by load switching to the LED 240.

Referring to FIG. 11, therein is depicted a circuit diagram of a circuit 265 that may be provided on the PCB 65 of the illumination assembly 25 according to various embodiments. The circuit 265 is similar to the circuit 235 except that the circuit 265 does not include the second resistor 260 and further includes a capacitor 270 that is connected in parallel with the LED 240. The capacitor 270 is configured to reduce or even eliminate flicker of the LED. For example, the capacitor 270 may ensure that the LED 240 is able to operate without flicker when powered. The diode 250 provide rectification of the AC power to DC power for the LED 240 and the resistor 245 provides appropriate size and wattage for the LED 240. The second diode 255 safeguards against voltage spikes caused by load switching to the LED 240.

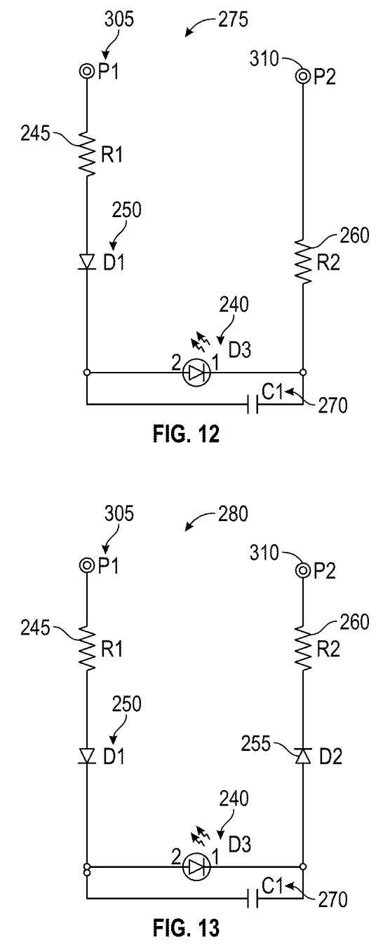

Referring to FIG. 12, therein is depicted a circuit diagram of a circuit 275 that may be provided on the PCB 65 of the illumination assembly 25 according to some embodiments. The circuit 275 is similar to the circuit 265 except that the circuit 275 does not include the second diode 255 and instead includes the second resistor 260. The diode 255 provides rectification of the AC power to DC power for the LED 240 and the resistors 245 and 260 provide appropriate size and wattage for the LED 240. The capacitor 270 ensures that the LED 240 is able to operate without flicker when powered.

Referring to FIG. 12, therein is depicted a circuit diagram of a circuit 280 that may be provided on the PCB 65 of the illumination assembly 25 according to exemplary embodiments. The circuit 280 is similar to the circuit 265 and the circuit 275 except that the circuit 280 includes both the second diode 255 and the second resistor 260. The diodes 250 and 255 provide rectification of the AC power to DC power for the LED 240 and the resistors 245 and 260 provide appropriate size and wattage for the LED 240. The capacitor 270 ensures that the LED 240 is able to operate without flicker when powered. The second diode 255 safeguards against voltage spikes caused by load switching to the LED 240.

FIG. 14 depicts an illustrative example of operating circuitry of an illumination assembly in accordance with the present disclosure. As shown in FIG. 14, the PCB 65 may include operating circuitry 301 that includes connection points P1305 and P2310, diodes 240, 250, 255, and/or 270, resistors 245 and 260, and LED diode 240. The operating circuitry 301 is provided for illustrative purposes and may be configured according to various alternative embodiments, such as the configurations depicted in FIGS. 10-13. The operating circuitry 301 may include one or more traces 302A-302F configured to electrically connect the elements of the operating circuitry 301.

P1 305 and P2 310 may be or may include connection points for electrically connecting contacts (for instance, contacts 70-73) to the operating circuitry 301, for example, via soldering or otherwise electrically connecting a contact (for instance, a contact of type 70-73) to a connection point P1 305 or P2310. P1 305 and P2 310 may include conductive material configured to make an electrical connection with the switch PCB connection portion 140 of a contact (for instance, a contact of type 70-73) when inserted through an aperture 115A or 115B (either before (for instance, via a friction fit or similar engagement) or after soldering or other joining process). In some embodiments, P1 305 and P2 310 may fully or partially encircle a respective aperture 115A or 115B.

While specific embodiments have been described in detail, it will be appreciated by those skilled in the art that various modifications and alternatives to those details could be developed in light of the overall teachings of the present disclosure. Accordingly, the particular arrangements disclosed are meant to be illustrative only and not limiting as to the scope of disclosed technologies which is to be given the full breadth of interpretation and any and all equivalents thereof.

What is claimed is:

1. An illumination assembly for an illuminated electrical switch device, comprising:
a printed circuit board (PCB) comprising:
at least one light emitting diode (LED), and
an operating circuitry electrically coupled to the LED; and
a pair of contacts, each of the pair of contacts formed of a conductive material and comprising a PCB connection end electrically coupled to the operating circuitry and a switch connection end, arranged opposite of the PCB connection end, configured to be electrically coupled to a switch contact of the illuminated electrical switch device to electrically couple the PCB to the illuminated electrical switch device.

2. The illumination assembly of claim 1, wherein the PCB comprises a pair of apertures, each of the pair of apertures at least partially surrounded by a connection point of the operating circuitry.

3. The illumination assembly of claim 2, wherein the PCB connection end of each of the pair of contacts is configured to be inserted through one of the pair of apertures and electrically coupled to the connection point of the one of the pair of apertures.

4. The illumination assembly of claim 2, wherein the PCB connection end comprises a resting collar configured to engage a bottom portion of the PCB and a soldering portion configured to extend through one of the pair of apertures to be soldered to the connection point.

5. The illumination assembly of claim 1, wherein each of the pair contacts is an elongated strip of the conductive material with the switch connection end having a curved portion forming a hook-shaped end.

6. The illumination assembly of claim 5, wherein the curved portion is configured to extend downward from the PCB into an interior cavity of the illuminated electrical switch device.

7. The illumination assembly of claim 5, wherein the switch connection end is configured to extend through a housing aperture of a top housing of the illuminated electrical switch device to engage the switch contact to electrically couple the PCB to the illuminated electrical switch device.

8. The illumination assembly of claim 5, wherein each of the pair of contacts is installed in a same orientation for a single pole illuminated electrical switch device with the switch connection end of each of the pair of contacts facing a same direction.

9. The illumination assembly of claim 5, wherein each of the pair of contacts is installed in a different orientation for a three-way illuminated electrical switch device with the switch connection end of each of the pair of contacts facing a different direction.

10. The illumination assembly of claim 1, wherein the operating circuit comprises a first resistor, a first diode, the LED, a second diode, and a second resistor electrically connected in series.

11. The illumination assembly of claim 10, wherein the first diode and the second diode provide rectification of AC power input into the illumination switch device to DC power for the LED.

12. The illumination assembly of claim 1, wherein the operating circuit comprises:
a first resistor, a first diode, the LED, and a second diode connected in series, and
a capacitor connected in parallel with the LED.

13. The illumination assembly of claim 12, wherein the capacitor is configured to reduce flicker of the LED when powered on.

14. An illuminated electrical switch device, comprising:
a top housing;
a line contact configured to be electrically coupled to a power source and a load contact configured to be electrically coupled to a load; and
a printed circuit board (PCB) assembly coupled to the top housing, the PCB assembly comprising:
a PCB including an operating circuit arranged on a top surface of the PCB, the operating circuit including a light emitting diode (LED) and circuitry structured for providing power to the LED when the illuminated electrical switch device is in an OFF condition from power that is received by the illuminated electrical switch device through the line contact and the load contact,
a first elongated contact coupled to the operating circuitry of the PCB and to the line contact, and
a second elongated contact coupled to the operating circuitry of the PCB and the load contact,
wherein the first elongated contact and the second elongated contact are configured to provide the power that is received by the illuminated electrical switch device to the operating circuit for powering the LED.

15. The illuminated electrical switch device of claim 14, wherein the top housing includes a first aperture structured for receiving a distal end of the first elongated contact and a second aperture structured for receiving a distal end of the second elongated contact when the PCB assembly is coupled to the top housing.

16. The illuminated electrical switch device of claim 15, wherein the top housing includes a first coupling element for snapping over and covering the PCB and a second coupling element for snapping over and covering the PCB when the distal end of the first elongated contact is received in the first aperture and the distal end of the second elongated contact is received in the second aperture when the PCB assembly is coupled to the top housing.

17. The illuminated electrical switch device of claim 14, wherein the first elongated contact and the second elongated contact each include a hollow body, a spring provided in the hollow body, and a plunger coupled to a proximal end of the spring and extending out of a proximal end of the hollow body to be electrically coupled to one of the line contact or the load contact.

18. An illuminated electrical switch device, comprising:
an enclosure comprising a top housing;
an actuator assembly configured to be actuated to place the illuminated electrical switch device in one of an ON state or an OFF state;
a line contact configured to be electrically coupled to a power source and a load contact configured to be electrically coupled to a load; and
an illumination assembly, comprising:
a printed circuit board (PCB) including at least one light emitting diode (LED) and an operating circuitry electrically coupled to the LED, and
a pair of contacts, each of the pair of contacts formed as a strip of conductive material and comprising a PCB connection end electrically coupled to the operating circuitry and a switch connection end, arranged opposite of the PCB connection end, electrically coupled to one of the line contact or the load contact,
wherein the illumination assembly is configured to illuminate a portion of the actuator assembly when the illuminated switch device is in the OFF state.

19. The illuminated switch device of claim 18, wherein:
the PCB comprises a pair of apertures, each of the pair of apertures at least partially surrounded by a connection point of the operating circuitry, and
the PCB connection end of each of the pair of contacts is configured to be inserted through one of the pair of apertures and electrically coupled to the connection point of the one of the pair of apertures.

20. The illuminated switch device of claim 18, wherein the switch connection end includes a curved portion extending downward from the PCB and through a housing aperture of the top housing to electrically couple with one of the line contact or the load contact.
